(19) United States
(12) Patent Application Publication
(10) Pub. No.: US 2018/0241120 A1
(43) Pub. Date: Aug. 23, 2018

(54) ANTENNA DEVICE AND TERMINAL FOR REDUCING ANTENNA CORRELATION OF MIMO SYSTEM

(71) Applicant: ZTE CORPORATION, Guangdong (CN)

(72) Inventor: Qun LI, Guangdong (CN)

(21) Appl. No.: 15/752,902

(22) PCT Filed: Sep. 28, 2015
(86) PCT No.: PCT/CN2015/090913

§ 371 Date: Feb. 15, 2018

(30) Foreign Application Priority Data
Aug. 25, 2015 (CN) 201510526740.3

(51) Int. Cl. H01Q 1/52; H01Q 21/28

(52) U.S. Cl. CPC H01Q 1/521; H01Q 1/243; H01Q 21/28

(57) ABSTRACT

Disclosed are an antenna device and a terminal for reducing antenna correlation of an MIMO system. The antenna device includes a support plate inside a terminal; a primary PCB and a secondary PCB supported by the support plate; a reed of a master antenna disposed on the secondary PCB; a first reed and a second reed of a slave antenna disposed on the primary PCB, respectively; and an RF coaxial cable configured to connect the primary PCB and the secondary PCB. The antenna device further comprises at least one slit formed within a non-PCB area of the support plate. A position and a length of the slit depend on a wavelength of a frequency point of an antenna to be improved and an alignment position and a feed position of the antenna in the entire terminal.

### CROSS-REFERENCE TO RELATED APPLICATION

This is a National Phase Application filed under 35 U.S.C. 371 as a national stage of PCT/CN2015/090913, filed Sep. 28, 2015, an application claiming priority to entitled “ANTENNA DEVICE AND TERMINAL FOR REDUCING ANTENNA CORRELATION OF MIMO SYSTEM” Chinese Patent Application NO. 201510526740.3, filed on Aug. 25, 2015, the disclosure of which is hereby incorporated by reference in its entirety.

### FIELD OF THE INVENTION

The present disclosure relates to antenna design technologies in the field of communication, and more particularly to an antenna device and a terminal for reducing antenna correlation of an MIMO (Multiple-Input Multiple-Output) system.

### BACKGROUND

In the process of implementing the technical solutions relating to the embodiments of the present application, the inventor of the present application has found at least the following technical problems existing in the related technologies:

Currently, mobile operators in various countries have begun to list the data throughput rate of mobile terminals supporting MIMO as a necessary item for certification test. Meanwhile, CTIA (Cellular Telecommunications and Internet Association) is also gradually improving the test scheme. It is expected that all terminals launched in U.S. market will be tested from 2016. This test case may involve a great number of contents and higher requirements on the antenna performance. The terminals that could meet an OTA standard of the operators in the past may not be able to meet an MIMO OTA test. The MIMO OTA test is a relatively comprehensive test closer to a practical application scenario of a user.

As could be seen from the first MIMO OTA certification project, the test result mainly depends on two performance indices of an antenna, wherein one is the receiving index of the antenna, and the other is the correlation between antennas. The receiving index of the antenna depends on the space of the antenna, that is, the antenna's clearance size, height, area, position in the terminal, and the like. When a layout of a terminal is determined, the performance of the antenna is basically determined, while the correlation between antennas depends on a distance between the antennas, an oriental pattern of the two antennas, a radiation intensity and radiation phase difference of the antenna, and the like. The lower the correlation, the better the throughput of MIMO will be. Therefore, it is important to reduce the antenna correlation. Taking a mobile phone terminal as an example, in light of the small size of a traditional mobile phone, when the mobile phone has a working frequency band of 700 MHz to 900 MHz, the antenna may provide strong mutual interference in the MIMO state, that is, a strong correlation, thereby leading to a lowered MIMO throughput rate. How to reduce the correlation of a terminal having a relatively small size, such as a mobile phone, in the low frequency band has become a difficult problem. Furthermore, it is also a challenge to improve MIMO throughput rate of a terminal such as a mobile phone in a low frequency band of 700 MHz to 900 MHz due to the correlation.

Traditional solutions to reduce antenna correlation may include: cutting a primary printed circuit board (PCB) to change a current direction; adding a ground electrode of nearly a quarter wavelength between antennas to isolate the antennas, wherein the slotted position is required to be at the middle of the two antennas and necessarily at the middle of the two antenna's signal feed positions; and adding decoupling circuit between the antennas, and the like.

The problem with employing these solutions is that these solutions are less practical for mobile phones to implement in view of universality since they are only applicable to a particular terminal layout and to a specific frequency.

### SUMMARY

In view of the above, embodiments of the present disclosure are intended to provide an antenna device and a terminal for reducing antenna correlation of an MIMO system, so as to solve at least the problems in the existing technologies.

The technical solutions of the embodiments of the present disclosure are as follows:

An embodiment of the disclosure provides an antenna device for reducing antenna correlation of an MIMO system, comprising: a support plate inside a terminal; a primary PCB and a secondary PCB supported by the support plate; a reed of a master antenna disposed on the secondary PCB; a first reed and a second reed of a slave antenna disposed on the primary PCB, respectively; and a radio frequency (RF) coaxial cable configured to connect the primary PCB and the secondary PCB. The antenna device further comprises at least one slit formed within a non-PCB area of the support plate. A position and a length of the slit depend on a wavelength of a frequency point of an antenna to be improved and an alignment position and a feed position of the antenna in the entire terminal.

In an exemplary embodiment, the antenna device further includes a slave antenna area on the primary PCB using the first reed as a feed point; and a master antenna area on the secondary PCB using the second reed as a feed point, two slits, as a first slit and a second slit, are formed within the non-PCB area of the support plate, —the first slit being located on an upper side of the second slit, a left side of the first slit is arranged to exceed the support plate such that the support plate is divided into upper and lower portions, while a right side of the first slit is arranged not to exceed the support plate, and a right side of the second slit is arranged to exceed the support plate, while a left side of the second slit is arranged not to exceed the support plate.

In an exemplary embodiment, a length of the first slit and/or the second slit and a position on the support plate are arranged to depend on a quarter wavelength of a center frequency point of a frequency band to be improved, and a maximum length of the first slit and/or the second slit is not allowed to exceed both edges of the support plate.

In an exemplary embodiment, a width of the support plate between the first slit and/or the second slit and joints on both edges of the support plate is arranged not to affect efficiency of the entire antenna.

In an exemplary embodiment, two slits, as a third slit and a fourth slit, are formed within the non-PCB area of the metal plate, the third slit being located on an upper side of the fourth slit, a first predetermined distance is provided between the third slit and each of edges of the metal support plate, and a left side of the fourth slit is in contact with one edge of the metal support plate while a second predetermined distance is provided between a right side of the fourth slit and the other edge of the metal support plate.

An embodiment of the disclosure also provides a terminal which includes the antenna device according to the embodiments of the disclosure.

The antenna device for reducing antenna correlation of an MIMO system according to the embodiments of the present disclosure includes: a support plate inside a terminal, a primary PCB and a secondary PCB supported by the support plate, a reed of a master antenna on the secondary PCB, a first reed and a second reed of a slave antenna disposed on the primary PCB, respectively, and an RF coaxial cable configured to connect the primary PCB and the secondary PCB. The antenna device further comprises: at least one slit formed within a non-PCB area of the support plate. A position and a length of the slit depend on a wavelength of a frequency point of an antenna to be improved and an alignment position and a feed position of the antenna in the entire terminal.

With the embodiments of the present disclosure, the antenna correlation of the MIMO system can be effectively reduced by forming at least one slit in the non-PCB area of the support plate.

### BRIEF DESCRIPTION OF THE DRAWINGS

FIG. 1 is one of schematic diagrams showing an internal layout structure of a mobile phone terminal applicable to an antenna device according to an embodiment of the present disclosure;

FIG. 2 is a schematic structural diagram showing a constitution of design scheme of the antenna device according to an embodiment of the present disclosure;

FIG. 3 is a schematic diagram showing the specific dimension of a design scheme of the layout in FIG. 2; and

FIG. 4 is a schematic structural diagram showing constitution of another design scheme of the antenna device according to an embodiment of the present disclosure.

### DETAILED DESCRIPTION OF THE EMBODIMENTS

The implementation of the technical solution will be further described in detail hereinafter with reference to the accompanying drawings.

An antenna device for reducing antenna correlation of an MIMO system according to an embodiment of the present disclosure includes: a support plate inside a terminal, a primary PCB and a secondary PCB supported by the support plate, a reed of a master antenna disposed on the secondary PCB, a first reed and a second reed of a slave antenna disposed on the primary PCB, respectively, and an RF coaxial cable configured to connect the primary PCB and the secondary PCB. The antenna device further comprises: at least one slit formed within a non-PCB area of the support plate. A position and a length of the slit depend on a wavelength of a frequency point of an antenna to be improved and an alignment position and a feed position of the antenna in the entire terminal.

In an implementation of an embodiment of the present disclosure, the antenna device further includes: a slave antenna area on the primary PCB using the first reed as a feed point, and a master antenna area on the secondary PCB using the second reed as a feed point. Two slits, as a first slit and a second slit, are formed within the non-PCB area of the support plate. The first slit is located on an upper side of the second slit. A left side of the first slit is arranged to exceed the support plate such that the support plate is divided into upper and lower portions, while a right side of the first slit is arranged not to exceed the support plate. A right side of the second slit is arranged to exceed the support plate, while a left side of the second slit is arranged not to exceed the support plate.

In an implementation of an embodiment of the present disclosure, a length of the first slit and/or the second slit and a position on the support plate are arranged to depend on a quarter wavelength of a center frequency point of a frequency band to be improved, and a maximum length of the first slit and/or the second slit is not allowed to exceed both edges of the support plate.

In an implementation of an embodiment of the present disclosure, a width of the support plate between the first slit and/or the second slit and joints on both edges of the support plate is arranged not to affect efficiency of the entire antenna.

In an implementation of an embodiment of the present disclosure, two slits, as a third slit and a fourth slit, are formed within the non-PCB area of the support plate. The third slit is located on an upper side of the fourth slit. A first predetermined distance is provided between the third slit and each of edges of the support plate. A left side of the fourth slit is in contact with one edge of the support plate while a second predetermined distance is provided between a right side of the fourth slit and the other edge of the support plate.

A terminal according to an embodiment of the present disclosure includes the antenna device according to any one of the foregoing embodiments.

Taking a practical application scenario as an example, an embodiment of the present disclosure will be described hereinafter.

In this application scenario, in order to reduce the antenna correlation of the MIMO system, two schemes are adopted to improve an isolation of the antenna, wherein one scheme is to add a decoupling circuit; and the other scheme is to add a grounded branch between two antennas, the slotted position of which is at the middle of the two antennas and necessarily at the middle of the two antenna's signal feed positions. However, these schemes are suitable for a specific terminal layout and specific frequencies such as higher than 5 GMHz, etc., and thus are not applicable for a mobile phone having a compact and small-sized layout.

This application scenario adopting the embodiment of the present disclosure is mainly applied to a terminal having a structure which has a layout of mobile phone formed as separate upper and lower plates and which is provided with a whole piece of support plate for supporting a screen, a PCB motherboard and the like. At least one slit is formed in the non-PCB area of the support plate. A position and length of the slit depend on a wavelength of the frequency point of the antenna to be improved and an alignment position and a feed position of the antenna in the entire terminal. Therefore, it is possible to effectively reduce the correlation between antennas without additional costs while the layout could not affect the EDA (Electronic Design Automation) layout of the PCB. In an embodiment, the support plate used herein can be a metal support plate.

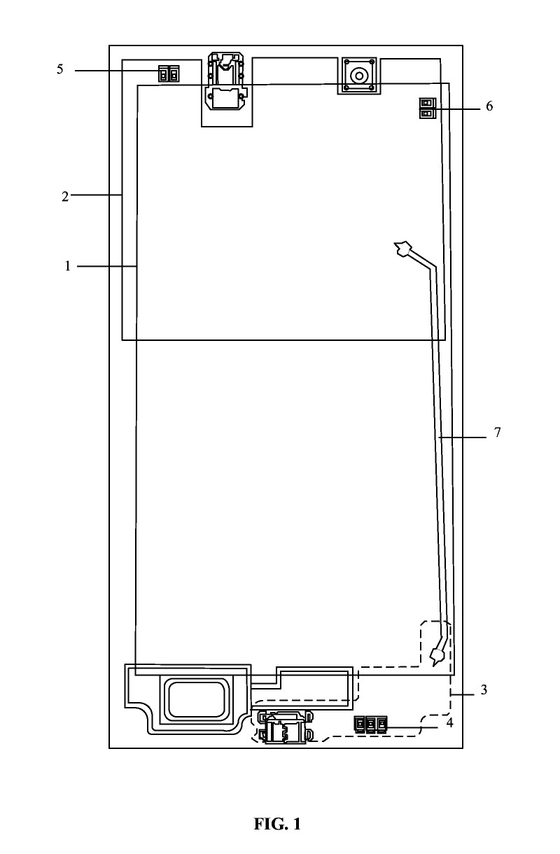

FIG. 1 is a basic layout of a mobile phone terminal used in an embodiment of the present disclosure in this application scenario. In FIG. 1, inside the mobile phone, a support plate 1, a primary PCB 2, a secondary PCB 3, a reed 4 of a master antenna, a first reed 5 of a slave antenna, a second reed 6 of the slave antenna, and an RF coaxial cable 7 are included. Among them, the support plate 1 is mainly used to support an incomplete and partitioned PCB, screen and other components inside the mobile phone. The primary PCB 2 is mainly used to place main RF and baseband chips of the mobile phone and functional devices which have a number of microstrip lines for connecting the devices and chips. The secondary PCB 3 is mainly used to place a USB, microphone, motor, speaker, master antenna and other components. The reed 4 of the master antenna is placed on the secondary PCB 3. The first reed 5 and the second reed 6 of the slave antenna are two respective reeds of the slave antenna placed on the primary PCB 2. The RF coaxial cable 7 is an RF coaxial cable configured to connect the primary PCB 2 and the secondary PCB 3 so that the master antenna on the lower secondary PCB can be operationally connected to the RF chip on the primary PCB.

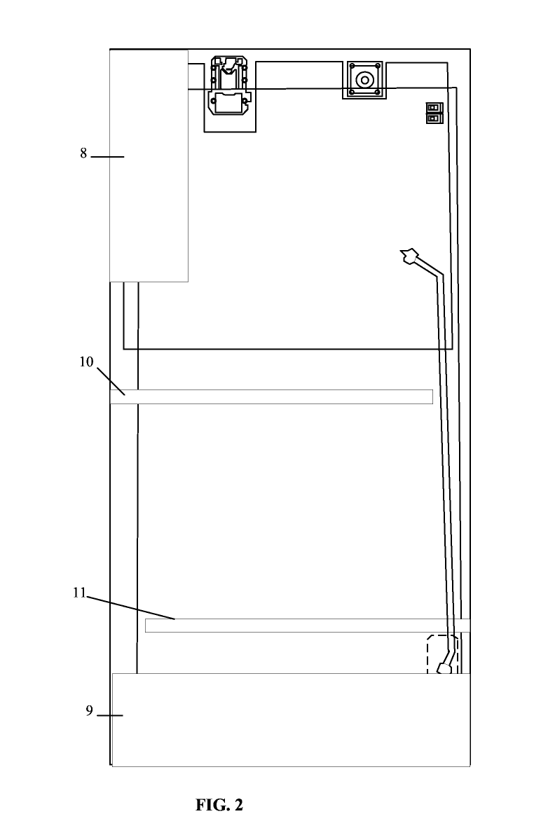

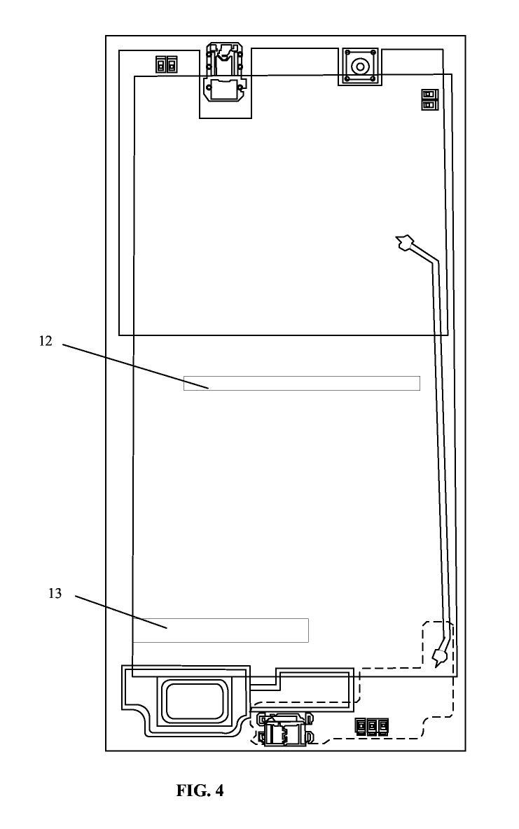

This embodiment of the present disclosure is a newly added technical solution based on the basic framework shown in FIG. 1. FIG. 2 and FIG. 4 are schematic diagrams illustrating the implementation of the solutions of the present disclosure on the basis of FIG. 1, respectively.

A layout framework of a mobile phone shown in FIG. 2 is taken as an example for description. In FIG. 2, the layout framework of a mobile phone includes a slave antenna area 8, a master antenna area 9, a first slit 10 formed on the support plate, a second slit 11 formed on the support plate. Herein, the slave antenna area 8 is a slave antenna area in which the first reed 5 of the slave antenna on the primary PCB 2 is used as a feed point. The master antenna area 9 is a master antenna area in which the reed 4 of the master antenna on the secondary PCB 3 is used as a feed point. The first slit 10 formed on the support plate and the second slit 11 formed on the support plate may have the same or different slit width. Here, as an example, the first slit 10 has a slit width of about 1 mm, and the second slit 11 also has a slit width of about 1 mm. The first slit 10 is arranged such that the slit exceeds the support plate at a left side thereof to divide the support plate into upper and lower portions while not exceeding the support plate at a right side thereof. The second slit 11 is arranged such that the slit exceeds the support plate at a right side thereof while not exceeding the support plate at a left side thereof. Lengths of the first slit 10 and the second slit 11 and positions thereof on the support plate depend on a length of the quarter-wavelength of a center frequency point of the frequency band to be improved. However, a maximum length is not allowed to exceed both edges of the support plate; otherwise a path of antenna backflow would be relatively small, thus affecting the radiation efficiency in low-frequency band. A width of the support plate between the slits and joints on both edges of the support plate is arranged not to affect the efficiency of the antenna.

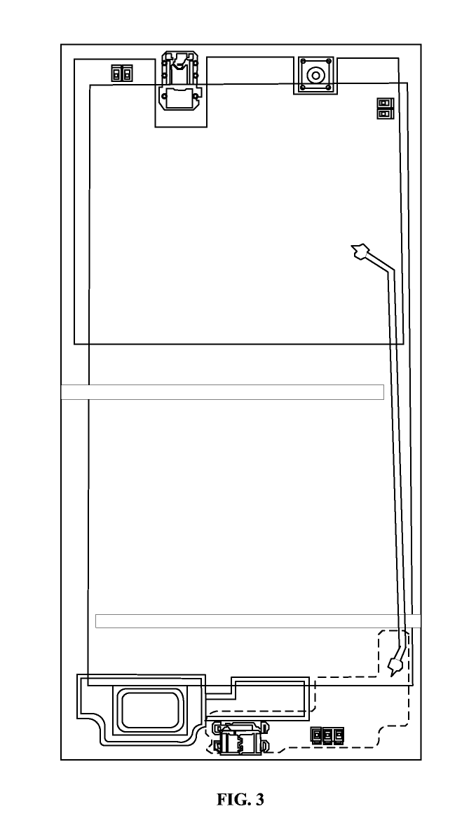

FIG. 3 shows a schematic diagram of the specific dimension based on the layout in FIG. 2. For the layout shown in FIG. 2, in case where the support plate, the primary PCB and the secondary PCB have a total maximum length of 130 mm and a width of 65 mm, when the antenna can realize a diversity reception of a low-frequency band of 850 MHz at the position of the slave antenna area 8 and a main reception and transmission antenna of low-frequency band of 850 MHz at the position of the master antenna area 9, it has been experimentally found that an ECC for the two antennas reaches 0.5 at 881 MHz when the support plate includes no slit. However, the CTIA specification requires the ECC to be less than 0.5. When a slit having a size as shown in FIG. 3 is formed at the position of the first slit 10, the ECC for the two antennas at 881 MHz is reduced to 0.3, but the receiving efficiency at the master antenna area 9 is slightly lowered at this time, equivalent to reducing the ECC to a certain extent. When a second slit 11 having a slit size as shown in FIG. 3 is additionally formed, the antenna efficiency at the slave antenna area 8 and the master antenna area 9 can be kept unchanged, but the ECC for the two antennas at 881 MHz is reduced to 0.1. It shows that by providing the first slit 10 and the second slit 11 on the support plate, the two slits can play a significant role in reducing the ECC. The position of the slit depends on

$$λ = \frac{{λ}_{0}}{\sqrt{ξ}} ,$$

wherein λ₀ represents a wavelength of the frequency point (in this example, 881 MHz) to be improved in the air, and ξ epresents a dielectric constant of the PCB. The position of the slit has a distance d from the feed position of the antenna which is approximately a quarter of λ. However, in actual projects, it has been found that the position of the slit deviates from the quarter of λ to a certain degree since the dielectric constant of the medium cannot be accurately predicted or the current may pass through various medium having different dielectric constants. A fine-tuning is needed according to the actual situation.

Description will be provided by taking the layout framework of a mobile phone shown in FIG. 4 as an example. FIG. 4 may be used as an alternative solution for the layout of the mobile phone as shown in FIG. 2 and the specific dimension of the layout of the mobile phone as shown in FIG. 3. It has been found experimentally that the slitting scheme as shown in FIG. 4 can also achieve the same effect of reducing ECC. FIG. 4 also includes two slits which are the third slit 12 and the fourth slit 13, respectively. The third slit 12 and the fourth slit 13 may have the same or different slit width. In this example, the slit widths of the two slits are different. Different from the arrangement of the slits in FIG. 2, in this embodiment, either side of the third slit 12 may not exceed one edge of the support plate. In other words, the slit is distanced from both edges of the support plate. The third slit 12 has a width of about 1 mm. When the fourth slit 13 is wider, for example, with a width more than 3 mm, a left-right length of the fourth slit 13 can be reduced, which can also achieve the effect of reducing the ECC.

It should be noted that although each of the layouts as shown in FIG. 2 and FIG. 4 includes two slits, in practical applications, only one or more than two slits may be provided. For example, it has been experimentally found that the first slit 10 and the second slit 11 are both helpful to reduce the ECC. However, the current position of the first slit 10 is inclined to affect the efficiency of the main frequency antenna. Therefore, only a second slit 11 may be formed at the position as shown in FIG. 3 as required. Or when there is a certain margin in the radiation efficiency of the main frequency antenna, only one first slit 10 is provided at the position as shown in FIG. 3. All of these arrangements of slits can achieve the effect of reducing the ECC.

The above descriptions are merely preferred embodiments of the present disclosure and are not intended to limit the protection scope of the present disclosure.

### INDUSTRIAL UTILITY

The antenna device for reducing antenna correlation of an MIMO system according to the embodiments of the present disclosure includes: a support plate inside a terminal, a primary printed circuit board (PCB) and a secondary PCB supported by the support plate, a reed of a master antenna on the secondary PCB board, a first reed and a second reed of a slave antenna disposed on the primary PCB, respectively, and a radio frequency (RF) coaxial cable configured to connect the primary PCB and the secondary PCB. The antenna device further comprises: at least one slit formed within a non-PCB area of the support plate. A position and a length of the slit depend on a wavelength of a frequency point of an antenna to be improved and an alignment position and a feed position of the antenna in the entire terminal. With the embodiments of the present disclosure, the antenna correlation of the MIMO system can be effectively reduced by forming at least one slit in the non-PCB area of the support plate.

1. An antenna device for reducing antenna correlation of an MIMO system, comprising:
a support plate;
a primary PCB and a secondary PCB supported by the support plate;
a reed of a master antenna disposed on the secondary PCB;
a first reed and a second reed of a slave antenna disposed on the primary PCB, respectively; and
an RF coaxial cable configured to connect the primary PCB and the secondary PCB,
the antenna device further comprises at least one slit formed within a non-PCB area of the support plate, and
a position and a length of the slit depend on a wavelength of a frequency point of an antenna to be improved and an alignment position and a feed position of the antenna in an entire terminal.

2. The antenna device according to claim 1, further comprising: a slave antenna area on the primary PCB using the first reed as a feed point; and a master antenna area on the secondary PCB using the second reed as a feed point, two slits, as a first slit and a second slit, are formed within the non-PCB area of the support plate, the first slit being located on an upper side of the second slit,
a left side of the first slit is arranged to exceed the support plate such that the support plate is divided into upper and lower portions, while a right side of the first slit is arranged not to exceed the support plate, and
a right side of the second slit is arranged to exceed the support plate, while a left side of the second slit is arranged not to exceed the support plate.

3. The antenna device according to claim 2, wherein a length of the first slit and/or the second slit and a position on the support plate are arranged to depend on a quarter wavelength of a center frequency point of a frequency band to be improved, and a maximum length of the first slit and/or the second slit is not allowed to exceed both edges of the support plate.

4. The antenna device according to claim 2, wherein a width of the support plate between the first slit and/or the second slit and joints on both edges of the support plate is arranged not to affect efficiency of the entire antenna.

5. The antenna device according to claim 1, wherein two slits, as a third slit and a fourth slit, are formed within the non-PCB area of the support plate, the third slit being located on an upper side of the fourth slit,
a first predetermined distance is provided between the third slit and each of edges of the support plate, and
a left side of the fourth slit is in contact with one edge of the support plate while a second predetermined distance is provided between a right side of the fourth slit and the other edge of the support plate.

6. A terminal comprising an antenna device, wherein the antenna device comprises:
a support plate;
a primary PCB and a secondary PCB supported by the support plate;
a reed of a master antenna disposed on the secondary PCB;
a first reed and a second reed of a slave antenna disposed on the primary PCB, respectively; and
an RF coaxial cable configured to connect the primary PCB and the secondary PCB,
the antenna device further comprises at least one slit formed within a non-PCB area of the support plate, and
a position and a length of the slit depend on a wavelength of a frequency point of an antenna to be improved and an alignment position and a feed position of the antenna in the entire terminal.

7. The terminal according to claim 6, wherein the antenna device further comprises: a slave antenna area on the primary PCB using the first reed as a feed point; and a master antenna area on the secondary PCB using the second reed as a feed point,
two slits, as a first slit and a second slit, are formed within the non-PCB area of the support plate, the first slit being located on an upper side of the second slit,
a left side of the first slit is arranged to exceed the support plate such that the support plate is divided into upper and lower portions, while a right side of the first slit is arranged not to exceed the support plate, and
a right side of the second slit is arranged to exceed the support plate, while a left side of the second slit is arranged not to exceed the support plate.

8. The terminal according to claim 7, wherein a length of the first slit and/or the second slit and a position on the support plate are arranged to depend on a quarter wavelength of a center frequency point of a frequency band to be improved, and a maximum length of the first slit and/or the second slit is not allowed to exceed both edges of the support plate.

9. The terminal according to claim 7, wherein a width of the support plate between the first slit and/or the second slit and joints on both edges of the support plate is arranged not to affect efficiency of the entire antenna.

10. The terminal according to claim 6, wherein two slits, as a third slit and a fourth slit, are formed within the non-PCB area of the support plate, the third slit being located on an upper side of the fourth slit,
a first predetermined distance is provided between the third slit and each of edges of the support plate, and
a left side of the fourth slit is in contact with one edge of the support plate while a second predetermined distance is provided between a right side of the fourth slit and the other edge of the support plate.
